(19) United States
(12) Patent Application Publication
(10) Pub. No.: US 2023/0410083 A1
(43) Pub. Date: Dec. 21, 2023

(54) MANAGEMENT APPARATUS, MANAGEMENT METHOD, AND SETTLEMENT SYSTEM

(71) Applicant: TOYOTA JIDOSHA KABUSHIKI KAISHA, Toyota-shi Aichi-ken (JP)

(72) Inventor: Hiroya CHIBA, Fuji-shi Shizuoka-ken (JP)

(73) Assignee: TOYOTA JIDOSHA KABUSHIKI KAISHA, Toyota-shi Aichi-ken (JP)

(21) Appl. No.: 18/201,313

(22) Filed: May 24, 2023

(30) Foreign Application Priority Data
Jun. 20, 2022 (JP) 2022-098909

(51) Int. Cl. G06Q 20/30

(52) U.S. Cl. CPC G06Q 20/308

(57) ABSTRACT

The present disclosure relates to a management apparatus that manages settlement devices. The management apparatus manages a first settlement device that performs a settlement for use of a service or purchase of a product and a second settlement device mounted on a vehicle used by a user. The management apparatus comprises one or more processors. The one or more processors are configured to execute following two steps. The first step is permitting the first settlement device to perform a first settlement for the use of the service or the purchase of the product until the user using the service or purchasing the product gets in the vehicle. The second step is permitting at least the second settlement device to perform the first settlement after the user using the service or purchasing the product gets in the vehicle.

### CROSS-REFERENCE TO RELATED APPLICATION

The present application claims priority under 35 U.S.C. § 119 to Japanese Patent Application No. 2022-098909, filed Jun. 20, 2022, the contents of which application are incorporated herein by reference in their entirety.

### BACKGROUND

### Field

The present disclosure relates to a management apparatus that manages settlement devices, a management method for managing settlement devices, and a settlement system.

### Background Art

JP2019-079325A discloses a vehicle management system capable of reducing a waiting time from when a user of a vehicle finishes payment until when the user gets in the vehicle. The vehicle management system performs processing for associating the user with the vehicle when the vehicle enters a parking place and controls the vehicle to travel from the parking place to a pick-up/drop-off place for the user by cooperating with a vehicle controller of the vehicle associated with the user when the user finishes payment.

In addition to JP2019-079325A, JP2021-096510A and JP2020-027475A can be exemplified as documents showing the technical level in the technical field of the present disclosure at the time of filing.

### SUMMARY

As shown in JP2019-079325A, there is a situation in which a user of a vehicle shops at a commercial facility and then travels by the vehicle. In a situation like this, after using a service or purchasing a product, the user has to make payment for the service or the product before getting in the vehicle. Therefore, waiting time such as time for waiting in a line for payment sometimes occurs before getting in the vehicle.

The present disclosure is for the above-described problem. One object of the present disclosure is to provide a technique capable of reducing waiting time for payment of the user of the vehicle when the user uses the service or purchases the product.

The present disclosure provides a management apparatus that manages a first settlement device that performs a settlement for use of a service or purchase of a product and a second settlement device mounted on a vehicle used by a user.

The management apparatus comprises one or more processors.

The one or more processors are configured to execute:
permitting the first settlement device to perform a first settlement for the use of the service or the purchase of the product until the user using the service or purchasing the product gets in the vehicle; and
permitting at least the second settlement device to perform the first settlement after the user using the service or purchasing the product gets in the vehicle.

The present disclosure provides a management method for managing a first settlement device that performs a settlement for use of a service or purchase of a product and a second settlement device mounted on a vehicle used by a user.

The management method comprises:
permitting the first settlement device to perform a first settlement for the use of the service or the purchase of the product until the user using the service or purchasing the product gets in the vehicle; and
permitting at least the second settlement device to perform the first settlement after the user using the service or purchasing the product gets in the vehicle.

The present disclosure provides a settlement system including a first settlement device that performs a settlement for use of a service or purchase of a product and a second settlement device mounted on a vehicle used by a user.

The settlement system comprises one or more processors.

The one or more processors are configured to execute:
permitting the first settlement device to perform a first settlement for the use of the service or the purchase of the product until the user using the service or purchasing the product gets in the vehicle; and
permitting at least the second settlement device to perform the first settlement after the user using the service or purchasing the product gets in the vehicle.

According to the technique of the present disclosure, it is possible to reduce waiting time for payment of a user of a vehicle when the user uses a service or purchases a product.

### BRIEF DESCRIPTION OF THE DRAWINGS

FIG. 1 is a schematic diagram for explaining an overview of settlement performed by a settlement device according to an embodiment of the present disclosure.

FIG. 2 is a schematic diagram for explaining management information stored in a management apparatus according to the embodiment of the present disclosure.

FIG. 3 is a schematic diagram for explaining an effect of the present disclosure.

FIG. 4 is a block diagram showing a configurational example of a settlement system according to the embodiment of the present disclosure.

FIG. 5 is a flowchart showing an example of processing executed by the management apparatus according to the embodiment of the present disclosure.

FIG. 6 is a flowchart showing another example of processing executed by the management apparatus according to the embodiment of the present disclosure.

FIG. 7 is a flowchart showing another example of processing executed by the management apparatus according to the embodiment of the present disclosure.

FIG. 8 is a flowchart showing another example of processing executed by the management apparatus according to the embodiment of the present disclosure.

### DETAILED DESCRIPTION

Embodiments of the present disclosure will be described with reference to the accompanying drawings.

### 1. Overview

A situation in which a user of a vehicle uses a service or purchases a product in a commercial facility and then travels by the vehicle is considered. The user has to make payment for the service or the product after using the service or purchasing the product. In general, the user has to make payment in a facility where he/she uses the service or purchases the product and can leave the facility and get in the vehicle only after finishing payment.

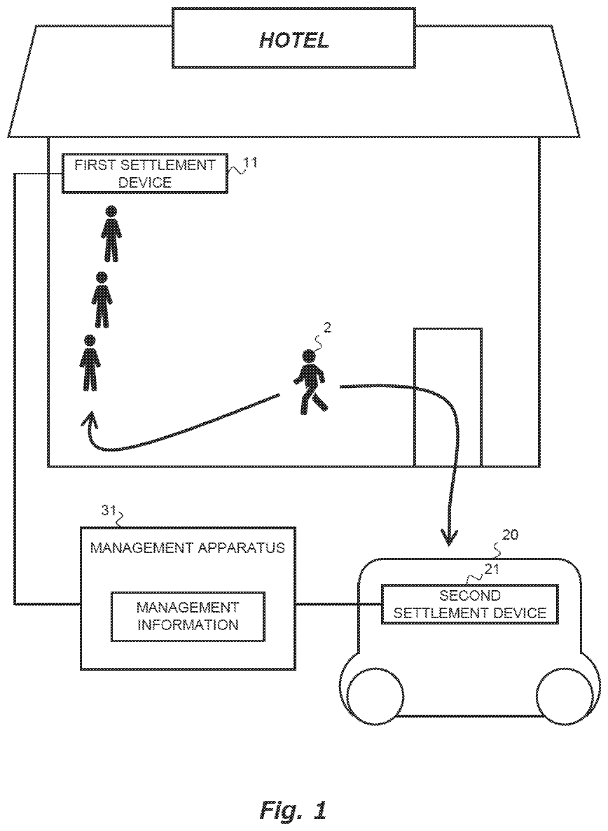

FIG. 1 shows a situation in which a user 2 makes payment after using a staying service in a hotel. The user 2 plans to travel by a vehicle 20 after finishing the payment. In general, the user 2 has to make the payment by a first settlement device 11, which is installed in a facility such as the hotel. However, there is a line of people waiting for payment at the first settlement device 11, so the user 2 has to wait in the line to make the payment. Since the user 2 can get in the vehicle 20 only after finishing the payment, waiting time of the user 2 becomes longer as the line is longer.

A service provided in the commercial facility such as the hotel is sometimes accompanied by a service using the vehicle 20. For example, a service of moving the vehicle 20 from the parking place attached to the hotel to an entrance of the hotel by AVP (automated valet parking) when the user 2 checks out from the hotel is assumed to be provided together with the staying service. However, even when such an accompanying service is provided, the vehicle 20 can be moved to the entrance of the hotel only after the user 2 finishes the payment. Therefore, waiting time until the user 2 gets in the vehicle 20 also becomes longer as waiting time until the user 2 finishes the payment becomes longer. For the user 2, benefit of the accompanying service using the vehicle 20 is reduced.

An object of the present disclosure is to reduce waiting time for payment which occurs before the user 2 gets in the vehicle 20 as described above. In order to reduce waiting time of the user 2, a management apparatus 31 according to the present embodiment enables the user 2 to make payment by the second settlement device 21 mounted on the vehicle 20 instead of the first settlement device 11.

Payment which the user 2 can make by the second settlement device 21 is not limited to payment for a service or a product accompanied by the service using the vehicle 20 and also includes payment for a service or a product which is not related to the vehicle 20 and is provided only in the commercial facility. In addition, in the present embodiment, when the user 2 can make payment for a plurality of services or products collectively by the first settlement device 11, the user 2 can also make payment collectively by the second settlement device 21.

The management apparatus 31 manages the first settlement device 11 and the second settlement device 21 in order to enable the user 2 to make payment by the second settlement device 21. The management performed by the management apparatus 31 includes permission or prohibition of a settlement for the first settlement device 11 or the second settlement device 21, transmission or reception of information relating to the settlement to/from the first settlement device 11 or the second settlement device 21, and the like. The settlement performed by the first settlement device 11 or the second settlement device 21 is accepting payment by the user 2 for a service used by the user 2 or a product purchased by the user 2 and make the payment finished. The management apparatus 31 stores management information in order to manage the first settlement device 11 and the second settlement device 21.

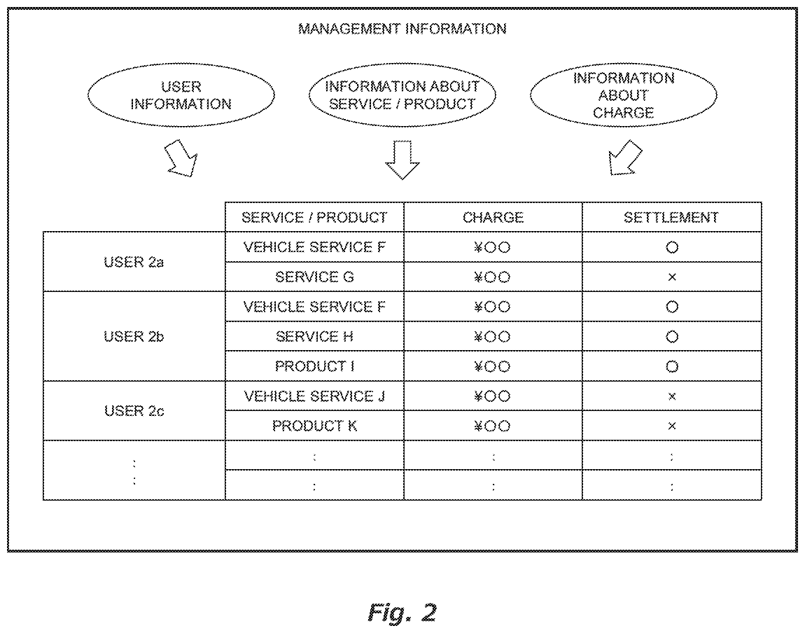

FIG. 2 is a schematic diagram showing an example of the management information stored in the management apparatus 31. The management information is information in which information of the user 2 and information necessary for the settlement are associated with each other. For example, in the management information shown in FIG. 2, a charge for a service used or a product purchased by each user 2 and whether the settlement for each service or product is completed are associated with each other with respect to a plurality of users 2 (users 2a, 2b, and 2c).

For example, the management apparatus 31 transmits the information necessary for the settlement of the user 2a out of the management information to the first settlement device 11 when permitting the first settlement device 11 to perform the settlement of the user 2a. The user 2a gets in a vehicle 20x, for example, and then, the management apparatus 31 transmits the information necessary for the settlement of the user 2a out of the management information to a second settlement device 21x mounted on the vehicle 20x when permitting the second settlement device 21x to perform the settlement. The first settlement device 11 and the second settlement device 21x can perform the settlement of the user 2a based on the transmitted management information.

The management apparatus 31 creates the management information from user information, information about a use situation of a service or a purchase situation of a product, information about a settlement situation thereof, information about a charge for a service or a product, and the like. The user information includes information for identifying the user 2, such as a user ID. The management apparatus 31 may acquire the user information from a mobile terminal such as a smartphone owned by the user 2 or may receive the user information from an administrator of the vehicle 20, for example. The information about the use situation of the service or the purchase situation of the product and the information about the settlement situation thereof are, for example, input into the management apparatus 31 by an employee of the commercial facility via a terminal in the commercial facility. The information about the charge for the service or the product may be given by an administrator of a store in the commercial facility and stored in a memory of the management apparatus 31 in advance, or may be input into the management apparatus 31 by the employee of the commercial facility via the terminal in the commercial facility.

The management information may further include information about the vehicle 20 in which the user 2 rides associated with above-described information. For example, if it becomes clear that the user 2a rides in the vehicle 20x in advance, the management apparatus 31 can associate the user 2a with information of the vehicle 20x and the information necessary for the settlement of the user 2a and store them as the management information.

When the vehicle 20 in which the user 2 rides becomes clear in advance, for example, when the vehicle 20 is individually owned by the user 2, information about the vehicle 20 in which the user 2 rides may be given to the management apparatus 31 together with the user information. When the vehicle 20 is a rental car or a shared car, information about the vehicle 20 in which the user 2 rides may be transmitted from the mobile terminal of the user 2 to the management apparatus 31 at the time of reservation of the vehicle 20 by the user 2. Alternatively, when the staying service in the hotel and the AVP service of the vehicle 20 for a guest of the hotel are provided in a set, information about the vehicle 20 in which the user 2 rides may be given to the management apparatus 31 together with a use situation of the staying service by a user.

The management apparatus 31 may create the management information by acquiring information in which the user information and other information are associated with each other in advance. For example, it is assumed that the user 2 makes a service reservation by using an application for making a reservation for the staying service in the hotel and the AVP service of the vehicle 20 in a set. In such a case, at the time when the reservation is completed, the management apparatus 31 can acquire, from the application, the user information and information associated with it such as the charge for the staying service, the charge for the AVP service of the vehicle 20, information about the vehicle 20 in which the user 2 is scheduled to ride, and the like.

Hereinafter, in the present description, the settlement for use of the service or purchase of the product by the user 2 is referred to as a first settlement. The management apparatus 31 permits the first settlement device 11 to perform the first settlement until the user 2 who uses the service or purchases the product gets in the vehicle 20. The management apparatus 31 permits at least the second settlement device 21 to perform the first settlement after the user 2 who uses the service or purchases the product gets in the vehicle 20. As a result, the user 2 can also make payment by the second settlement device 21 after getting in the vehicle instead of making payment by the first settlement device 11.

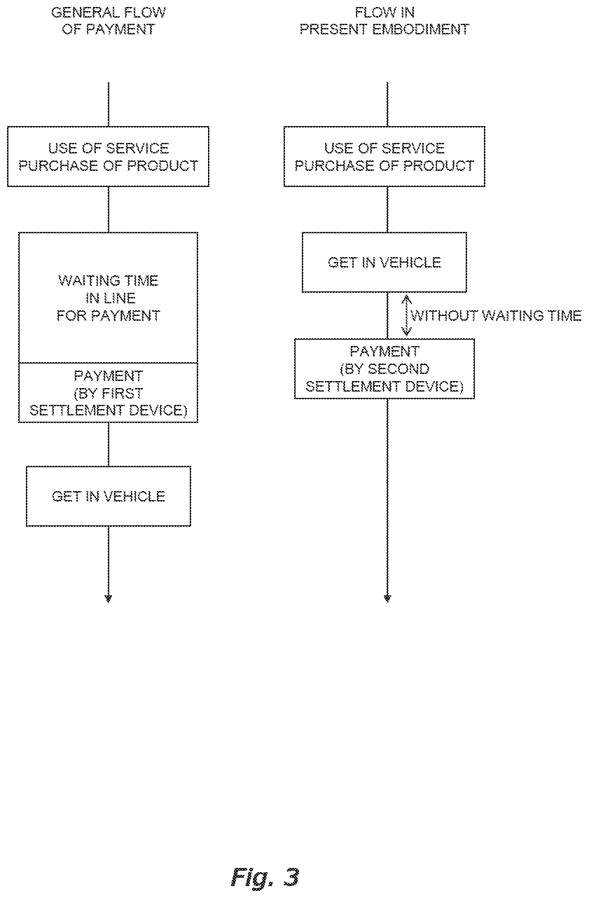

FIG. 3 is a diagram for comparing a flow of payment enabled by the present embodiment with a general flow of payment. In the general flow, the user 2 who uses the service or purchases the product gets in the vehicle 20 after making payment by the first settlement device 11. Before making the payment, the user 2 sometimes has to get into a line of people waiting for payment. Because of this, the user 2 sometimes wait a long time before getting in the vehicle 20.

On the other hand, in the present embodiment, the user 2 who uses the service or purchases the product can immediately get in the vehicle 20 without waiting time for the payment. After getting in the vehicle 20, the user 2 makes payment by the second settlement device 21. At the time of payment by the second settlement device 21, waiting time such as waiting time in a line does not occur. As described above, according to the present embodiment, waiting time until the user 2 gets in the vehicle 20 is reduced, and convenience of the user 2 can be improved.

As a method of reducing waiting time of the user 2 until the user 2 gets in the vehicle a method in which the user 2 makes payment using a terminal such as the smartphone owned by the user 2 may be considered. However, when the user 2 makes payment using the smartphone, procedures such as opening a browser and searching for a page for payment are required.

On the other hand, in the present embodiment, when the user 2 gets in the vehicle 20, the management apparatus 31 permits the second settlement device 21 to perform the settlement of the user 2. Information necessary for the user 2 to make payment is transmitted from the management apparatus 31 to the second settlement device 21, and the user 2 can seamlessly make payment by the second settlement device 21 without a troublesome procedure such as searching a page for payment.

### 2. Configuration

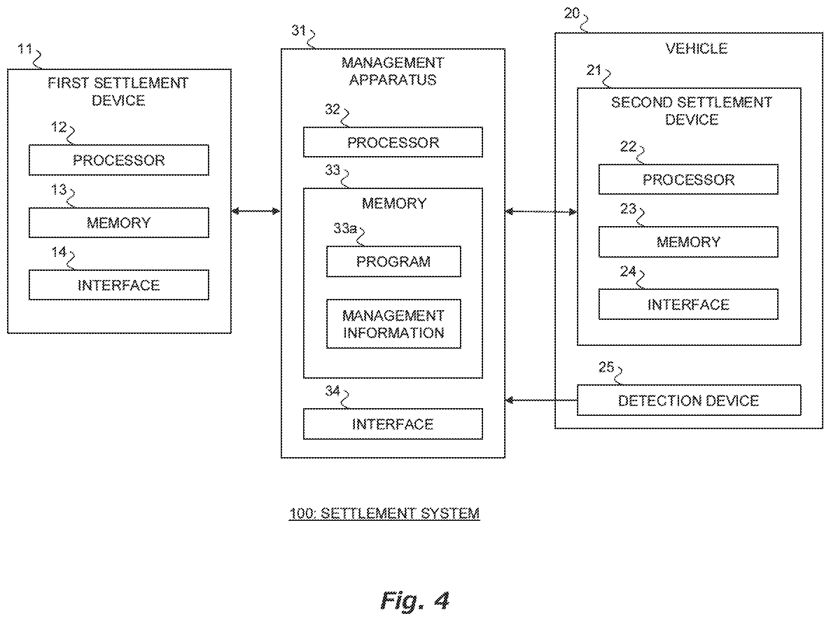

FIG. 4 is a block diagram showing a configurational example of a settlement system 100 according to the present embodiment. The settlement system 100 includes the first settlement device 11, the second settlement device 21, and the management apparatus 31.

The first settlement device 11 is a device that performs the settlement for use of the service or purchase of the product by the user 2. For example, the first settlement device 11 is a device such as a register installed in the commercial facility. The first settlement is the settlement for use of the service or purchase of the product by the user 2. Originally, the first settlement is performed by the first settlement device 11. The service or the product which is a target of the first settlement is provided for the user 2 in various commercial facilities such as the hotel, a restaurant, a department store, a shopping mall, a convenience store, a supermarket, or the like.

The service or the product which is the target of the first settlement may include a plurality of services or a plurality of products and may include different types of services or different types of products. For example, a transfer service or the AVP service using the vehicle 20 is sometimes provided at the hotel or the restaurant as a service integrated with a service such as the staying service or a meal service. The first settlement may include a settlement for the service using the vehicle 20 which is integrated with the service or the product provided in the commercial facility as described above. Examples of the transfer service using the vehicle 20 include a service using the vehicle 20 as the rental car or the shared car. The AVP service using the vehicle 20 includes the AVP service in a case where the vehicle 20 is individually owned by the user 2 and the AVP service in a case where the vehicle 20 is the rental car or the shared car.

The first settlement device 11 includes one or more processors 12 (hereinafter simply referred to as a processor 12), one or more memories 13 (hereinafter simply referred to as a memory 13), and an interface 14. The memory 13 stores one or more programs executable by the processor 12 and various data related to the programs. The interface 14 includes a network interface for communicating with a network and a settlement interface for performing the first settlement. The first settlement device 11 can accept the payment of the user 2 by reading a payment code of a credit card or the smartphone via the settlement interface.

The first settlement device 11 is installed inside the commercial facility or at the entrance of the commercial facility. After using the service or purchasing the product in the commercial facility, the user 2 makes payment by the first settlement device 11 installed inside or at the entrance of the commercial facility and then can get into the vehicle 20. Information necessary for the first settlement device 11 to perform the first settlement of the user 2 is transmitted from the management apparatus 31 to the first settlement device 11.

The second settlement device 21 is mounted on the vehicle 20. The second settlement device 21 includes one or more processors 22 (hereinafter simply referred to as a processor 22), one or more memories 23 (hereinafter simply referred to as a memory 23), and an interface 24. The memory 23 stores one or more programs executable by the processor 22 and various data related to the programs. The interface 24 includes an interface for performing communication with a network and a settlement interface for performing the settlement. Since the second settlement device 21 includes the interface 24, the second settlement device 21 can also perform the first settlement, which can be performed by the first settlement device 11. Although not shown in the drawings, the second settlement device 21 further includes a device for notifying the user 2 of information related to the settlement. For example, the second settlement device 21 includes a display screen for displaying the information related to the settlement or a speaker for notifying the information related to the settlement by voice or sound.

In some embodiments, the commercial facility in which the first settlement device 11 is installed is provided with a space in which the vehicle 20 can be parked or stopped, such as the parking place, a rotary, or a vehicle entrance, so that the user 2 can immediately get in the vehicle 20 after using the service, purchasing the product, or finishing payment. However, the commercial facility in which the first settlement device 11 is installed does not necessarily have such a space, and the vehicle 20 may be parked in the parking place in an area different from the commercial facility in which the first settlement device 11 is installed.

The vehicle 20 may be owned by the user 2 or may be a shared vehicle such as the rental car or the shared car. Further, the vehicle 20 may be an AVP vehicle. In a case where the vehicle 20 is the AVP vehicle, the vehicle 20 may move from the parking place to the vehicle entrance of the commercial facility by autonomous driving by the AVP. For example, the vehicle 20 may be the AVP vehicle parked in the parking place attached to the commercial facility and may drive to the vehicle entrance of the commercial facility in response to a request from the user 2.

The vehicle 20 may be provided with a detection device 25. The detection device 25 is a device for detecting the user 2 getting in the vehicle 20. Examples of the detection device 25 include a pressure sensor mounted on a seat of the vehicle 20 and a camera which captures an image of the inside of the vehicle 20.

The management apparatus 31 includes one or more processors 32 (hereinafter simply referred to as a processor 32), one or more memories 33 (hereinafter simply referred to as a memory 33), and an interface 34. The memory 33 stores one or more programs 33a (hereinafter simply referred to as a program 33a) executable by the processor 32 and various data related to the program 33a. The data stored in the memory 33 include the management information. The interface 34 includes an interface for communicating with a network.

The management apparatus 31 communicates with the first settlement device 11, the second settlement device 21, the detection device 25, and the vehicle 20 via the interface 34 and transmits and receives various types of information. A network for communicating with the first settlement device 11 may be a wired network or a wireless network. The communication between the management apparatus 31 and the second settlement device 21 or the detection device 25 is performed by a wireless network. Further, the management apparatus 31 may communicate with the mobile terminal such as the smartphone owned by the user 2, the terminal in the commercial facility, or the like via the interface 34.

### 3. Flow of Processing

### 3-1. First Example

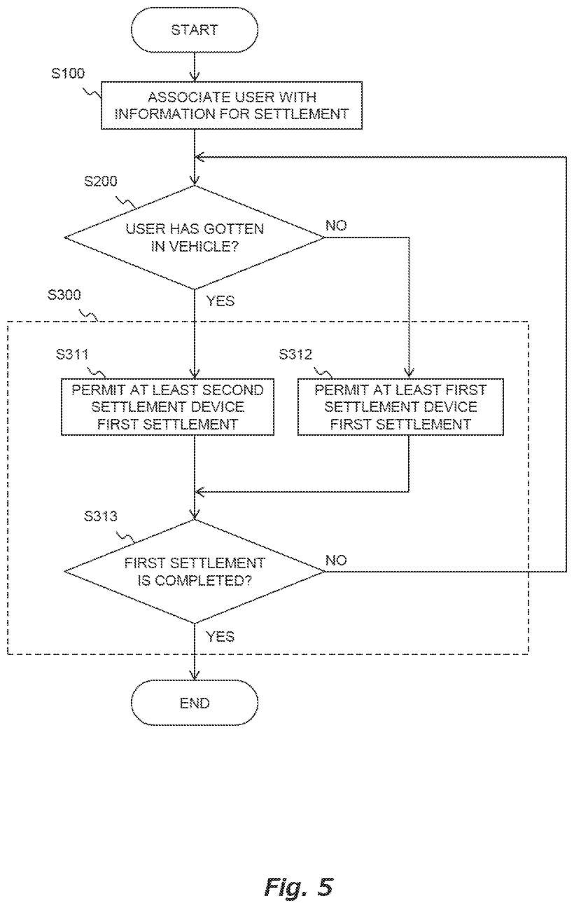

FIG. 5 is a flowchart showing the first example of processing executed by the management apparatus 31 to manage the first settlement device 11 and the second settlement device 21. The processing shown in FIG. 5 is realized by the processor 32 executing the program 33a. When the management apparatus 31 is notified that the user 2 uses the service or purchases the product, the processing of FIG. 5 starts.

In Step S100, the processor 32 associates the information necessary for the settlement with information of the user 2. The associated information is stored in the memory 33 as the management information. After the information is associated, the processing proceeds to Step S200.

In Step S200, the processor 32 determines whether the user 2 has gotten in the vehicle or not. Examples of how to determine whether the user 2 has gotten in the vehicle 20 or not are described above.

The first example is effective when the user 2 and the vehicle 20 are associated with each other in advance. In the first example, the processor 32 acquires information from the detection device 25. Then the processor 25 determines that the user 2 gets in the vehicle 20 when the detection device 25 detects a person who gets in the vehicle 20. For example, it is assumed that the user 2a and the vehicle 20x in which the user 20x is scheduled to ride are associated with each other in advance. When a detection device 25x mounted on the vehicle detects a person who gets in the vehicle 20x, the processor 32 determines that the user 2a gets in the vehicle 20x. For example, when the pressure sensor of the detection device 25x detects weight of a predetermined amount or more on the seat, the processor 32 determines that the user 2a gets in the vehicle 20x. Alternatively, for example, when the camera of the detection device 25x detects a person who gets in the vehicle 20x, the processor 32 determines that the user 2a gets in the vehicle 20x.

In the second example, the processor 32 determines whether the user 2 gets in the vehicle 20 by performing verification using identification information or the like. For example, a terminal for inputting user identification when the user 2 gets in the vehicle 20 is installed in the vehicle 20. Then, when the user identification of the user 2 is input into the terminal, it may be determined that the user 2 gets in the vehicle 20.

In the third example, the processor 32 determines whether the user 2 gets in the vehicle 20 by performing verification by face authentication. For example, data needed for the face authentication of the user 2 is stored in the memory 33 of the management apparatus 31 in advance. When the user 2 gets in the vehicle 20, the management apparatus 31 captures an image of the user 2 by the camera of the detection device 25. Then, when the user 2 is identified by the face authentication of the image, it may be determined that the user 2 gets in the vehicle 20. According to the second and third examples, even when the user 2 and the vehicle 20 are not associated with each other in advance, it is possible to determine whether the user 2 gets in the vehicle 20.

The fourth example is also effective when the user 2 and the vehicle 20 are associated with each other in advance. In the fourth example, the processor 32 determines that the user 2 gets in the vehicle 20 when the power of the vehicle 20 is turned on. For example, the vehicle 20 transmits a notification of power-on to the management apparatus 31 when the power of the vehicle 20 is turned on. When the management apparatus 31 receives the notification of power-on from the vehicle 20, the management apparatus 31 determines that the user 2 gets in the vehicle 20.

In a case where the vehicle 20 is the AVP vehicle, there is a case that the power of the vehicle 20 is turned on twice during a period from when the user 2 finishes use of the service or purchase of the product to when the user 2 gets in the vehicle 20.

For example, the power of the vehicle 20 is turned on/off in the following flow. When the user 2 finishes use of the service or purchase of the product and requests the vehicle 20 to move, an AVP management server, which manages the vehicle 20, turns on the power of the vehicle 20 parked in the parking place by remote control (the first time of turning on the power). After the power of the vehicle 20 is turned on, the vehicle 20 automatically travels from the parking place to a position where the user 2 gets in the vehicle 20. When the vehicle 20 arrives at the position, the power of the vehicle 20 is temporarily turned off. Thereafter, an operation authority of the vehicle 20 is transferred from the AVP management server to the user 2. The user 2, who has received the operation authority, gets in the vehicle 20 and turns on the power of the vehicle 20 (the second time of turning on the power).

In the fourth example, in a case where the power of the vehicle 20 is turned on twice as described above, the vehicle 20 may transmit the notification of power-on to the management apparatus 31 at the first time of turning on the power or may transmit the notification of power-on to the management apparatus 31 at the second time of turning on the power. When the management apparatus 31 receives the notification of power-on transmitted from the vehicle 20 (at the first time or at the second time), the management apparatus 31 determines that the user 2 gets in the vehicle 20. Although the user 2 has not gotten in the vehicle 20 yet at the first time of turning on the power, it is clarified that the user 2 will soon get in the vehicle 20. Therefore, even if the management apparatus 31 permits the second settlement device 21 to perform the settlement regarding the user 2 as having gotten in the vehicle 20, it does not matter.

After the determination in Step S200, the processing proceeds to Step S300. Step S300 includes Step S311, S312, and S313. If it is determined that the user 2 has gotten in the vehicle 20 in Step S200 (Step S200; Yes), the processing proceeds to Step S311. If it is not determined that the user 2 has gotten in the vehicle 20 (Step S200; No), the processing proceeds to Step S312.

In Step S311, the processor 32 permits at least the second settlement device 21 to perform the first settlement. The processor 32 may permit only to the second settlement device 21 to perform the first settlement or may permit both the first settlement device 11 and the second settlement device 21 to perform the first settlement. After at least the second settlement device 21 is permitted to perform the first settlement, the processing proceeds to Step S313. Information necessary for the second settlement device 21 to perform the first settlement is transmitted to the second settlement device by the processor 32 out of the management information stored in the memory 33. The information may be transmitted at the time when the second settlement device 21 is permitted to perform the first settlement or, in a case where the user 2 and the vehicle 20 are associated with each other in advance, may be transmitted in advance.

In Step S311, the management apparatus 31 may display information relating to the settlement of the user 2 on the display screen of the second settlement device 21 at the time when permitting the second settlement device 21 to perform the settlement. In this case, since the user 2 does not need to open a page for the settlement, that is, less operation is required of the user 2, the user 2 can make payment more smoothly.

In Step S312, the processor 32 permits at least the first settlement device 11 to perform the first settlement. The processor 32 may permit only to the first settlement device 21 to perform the first settlement or may permit both the first settlement device 11 and the second settlement device 21 to perform the first settlement. Information necessary for the first settlement device 11 to perform the first settlement is transmitted to the first settlement device 11 by the processor 32 out of the management information stored in the memory 33. The information may be transmitted at the time when the first settlement device 11 is permitted to perform the first settlement or may be transmitted in advance. After at least the first settlement device 11 is permitted to perform the first settlement, the processing proceeds to Step S313.

In Step S313, the processor 32 determines whether the first settlement, which is performed by the first settlement device 11 or the second settlement device 21, is completed or not. If the first settlement by any one of the settlement devices is completed (Step S313; Yes), the processing ends. If the first settlement is not completed by either of the settlement devices (Step S313; No), the processing returns to Step S200.

As an effect common to the first example and the following examples of processing, the user 2 can make payment by the second settlement device 21 after getting in the vehicle 20. After using the service or purchasing the product in the commercial facility, the user 2 can get in the vehicle 20 without spending waiting time for making payment by the first settlement device 11. Further, an additional procedure is not required of the user 2 because the first settlement is seamlessly permitted to be performed by the second settlement device 21 in response to the user 2 getting in the vehicle 20. In this way, according to the present embodiment, it is possible to reduce waiting time of the user 2 occurring until the user 2 gets in the vehicle 20 and to improve convenience of the user 2. Further, it is also possible to reduce congestion caused by a line of people waiting for payment.

In addition, until the user 2 gets in the vehicle 20, the user 2 can make payment by the first settlement device 11 as general. Therefore, even if the user 2 wants to remain in the commercial facility after finishing payment or wants to cancel using the vehicle 20 after using the service or purchasing the product in the commercial facility, convenience of the user 2 is not hindered.

### 3-2. Second Example

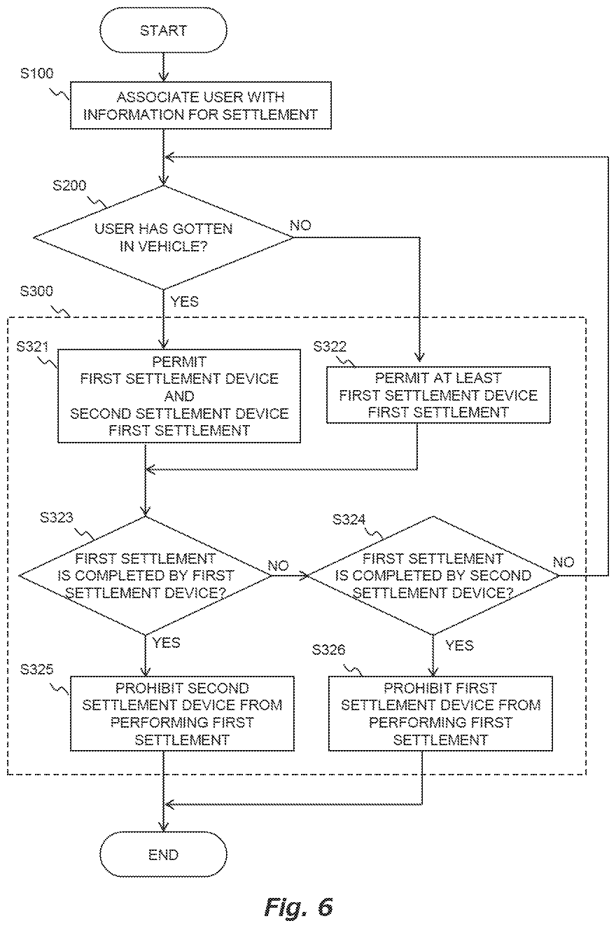

FIG. 6 is a flowchart showing the second example of processing executed by the management apparatus 31 to manage the first settlement device 11 and the second settlement device 21. The second example is different from the first example in the process of Step S300.

In Step S100 and Step S200, the same processes are executed as the first example. If it is determined that the user 2 has gotten in the vehicle 20 in Step S200 (Step S200; Yes), the processing proceeds to Step S321. If it is not determined that the user 2 has gotten in the vehicle 20 (Step S200; No), the processing proceeds to Step S322.

In Step S321, the processor 32 permits both the first settlement device 11 and the second settlement device 21 to perform the first settlement. After the first settlement is permitted to be performed, the processing proceeds to Step S323.

In Step S322, the processor 32 permits at least the first settlement device 11 to perform the first settlement. The processor 32 may permit only to the first settlement device 21 to perform the first settlement or may permit both the first settlement device 11 and the second settlement device 21 to perform the first settlement. When the first settlement is permitted, the processing proceeds to Step S323.

In Step S323, the processor 32 determines whether the first settlement by the first settlement device 11 is completed or not. If the first settlement by the first settlement device 11 is completed (Step S323; Yes), the processing proceeds to Step S325. If the first settlement by the first settlement device 11 is not completed (Step S323; No), the processing proceeds to Step S324.

In Step S324, the processor 32 determines whether the first settlement by the second settlement device 21 is completed or not. If the first settlement by the second settlement device 21 is completed (Step S324; Yes), the processing proceeds to Step S326. If the first settlement by the second settlement device 21 is not completed (Step S324; No), the processing returns to Step S200.

In Step S325, the processor 32 prohibits the second settlement device 21 from performing the first settlement. After the first settlement by the second settlement device 21 is prohibited, the processing ends.

In Step S326, the processor 32 prohibits the first settlement device 11 from performing the first settlement. After the first settlement by the first settlement device 11 is prohibited, the processing ends.

According to the second example, a double settlement, that is a state where both the first settlement device 11 and the second settlement device 21 complete the same first settlement, is prevented. In the second example, when the first settlement by one of the first settlement device 11 and the second settlement device 21 is completed, the other settlement device is prohibited from performing the first settlement. Therefore, it is possible to prevent the double settlement from occurring, that is it is possible to prevent the same first settlement from being performed by both the first settlement device 11 and the second settlement device 21.

### 3-3. Third Example

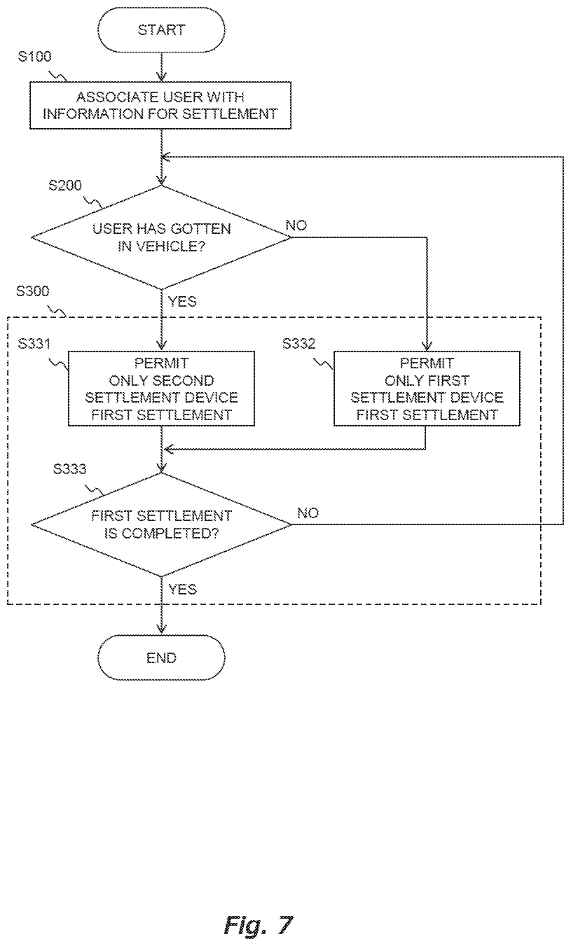

FIG. 7 is a flowchart showing the third example of processing executed by the management apparatus 31 to manage the first settlement device 11 and the second settlement device 21. The third example is different from the first and second examples in the process of Step S300.

In Step S100 and Step S200, the same processes are executed as the first and second examples. If it is determined that the user 2 has gotten in the vehicle 20 in Step S200 (Step; S200), the processing proceeds to Step S331. If it is not determined that the user 2 has gotten in the vehicle 20 (Step S200; No), the processing proceeds to Step S332.

In Step S331, the processor 32 permits only the second settlement device 21 to perform the first settlement. After the second settlement device 21 is permitted to perform the first settlement, the processing proceeds to Step S333.

In Step S332, the processor 32 permits only the first settlement device 11 to perform the first settlement. After the first settlement device 11 is permitted to perform the first settlement, the processing proceeds to Step S333.

In Step S333, the processor 32 determines whether the first settlement is completed by the first settlement device 11 or the second settlement device 21 or not. If the first settlement is completed (Step S333; Yes), the processing ends. If the first settlement is not completed (Step S333; No), the processing returns to Step S200.

According to the third example, the double settlement, in which both the first settlement device 11 and the second settlement device 21 complete the same first settlement, is also prevented. The management apparatus 31 permits only one of the first settlement device 11 and the second settlement device 21 to perform the first settlement at a time. Therefore, the same first settlement is not performed by both the first settlement device 11 and the second settlement device 21, and the double settlement is prevented.

### 3-4. Fourth Example

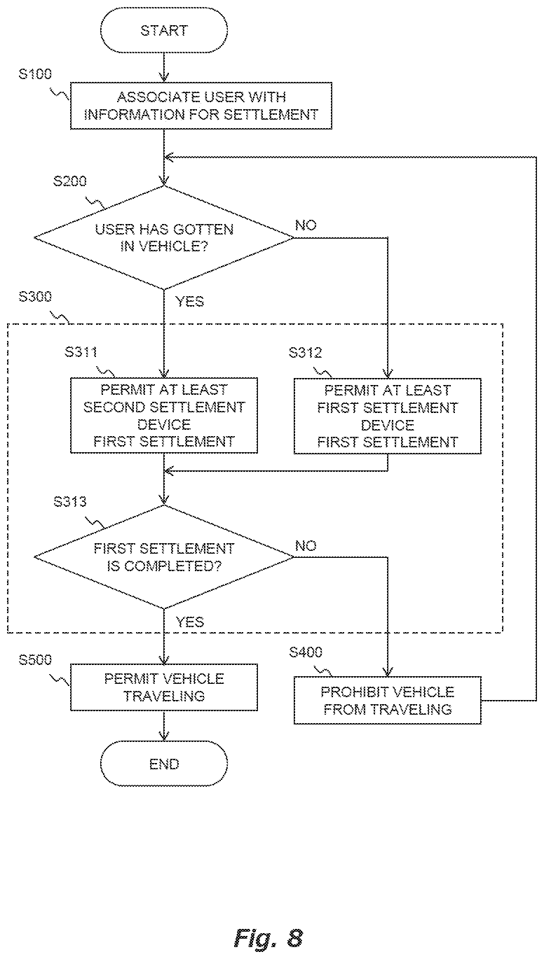

FIG. 8 is a flowchart showing the fourth example of processing executed by the management apparatus 31 to manage the first settlement device 11 and the second settlement device 21. The flowchart shown in FIG. 8 is realized by the processor 32 executing the program 33a. When the management apparatus 31 is notified that the user 2 has received the service or purchased the product, the processing in FIG. 8 starts.

In Step S100 and Step S200, the same processes are executed as the first example. In Step S300, any one of the processes of Step S300 in the first example, in the second example, and in the third example may be executed. In the following description, it is assumed that the process in Step S300 is the same as the first example.

Processes in Step S311, Step S312, and Step S313 are described in the first example. In Step S313, if it is determined that the first settlement is completed by any one of the settlement devices (Step S313; Yes), the processing proceeds to Step S500. If it is not determined that the first settlement is completed by any one of the settlement devices (Step S313; No), the processing proceeds to Step S400.

In Step S400, the processor 32 prohibits the vehicle 20 from traveling. After traveling is prohibited, the processing returns to Step S200. The vehicle 20 whose traveling is prohibited in Step S400 is the vehicle 20 in which the user 2 is scheduled to ride or is riding. However, when the vehicle 20 is the AVP vehicle, the vehicle 20 is permitted to automatically travel from the parking place to a getting in/out place. That is, in a case where the vehicle 20 is the AVP vehicle, the vehicle 20 in which the user 2 is riding is prohibited from traveling in Step S400. If the user 2 does not ride in the vehicle 20 and it is not determined which vehicle 20 the user 2 rides in before the process of Step S400 begins, the process of Step S400 is skipped, and the processing returns to Step S200.

In Step S500, the processor 32 permits the vehicle 20 to travel. After traveling is permitted, the processing ends. The vehicle 20 permitted to travel in Step S500 is the vehicle 20 in which the user 2 is scheduled to ride or is riding. If the user 2 does not ride in the vehicle 20 and it is not determined which vehicle 20 the user 2 rides in before the process of Step S500 begins, the process of Step S500 is skipped, and the processing ends.

According to the fourth example, the vehicle 20 is prohibited from traveling until the first settlement is completed by any one of the settlement devices. Since the vehicle 20 is prohibited from traveling, it is possible to prevent the user 2 from traveling by the vehicle 20 without making the first settlement completed, for example, for the reason that the user 2 forgets payment. After the first settlement is completed, traveling of the vehicle 20 is permitted, and the user 2 can travel by the vehicle 20.

### 4. Another Embodiment in which Second Settlement Device Performs Settlement for Vehicle Service

In this embodiment, the service using the vehicle 20 is provided to the user 2 as a service different from the service which is the target of the first settlement. Hereinafter, in this embodiment, the service using the vehicle 20, which is provided to the user 2 as the service different from the service that is the target of the first settlement, is referred to as a vehicle service. A settlement for the vehicle service is referred to as a second settlement. The second settlement can be performed by the second settlement device 21.

The vehicle service is a mobility service or the AVP service using the vehicle 20. The mobility service using the vehicle 20 is, for example, a service for traveling by using the vehicle 20 as the rental car or the shared car. The AVP service using the vehicle 20 includes an AVP service in a case where the vehicle 20 is individually owned by the user 2 and an AVP service in a case where the vehicle 20 is the rental car or the shared car.

In this embodiment, the management apparatus 31 permits the second settlement device 21 to collectively perform the first settlement and the second settlement when permitting the second settlement device 21 to perform the first settlement. In this embodiment, the user 2 can also make payment by the second settlement device 21. Instead of making payment by the first settlement device 11 after spending waiting time, the user 2 can get in the vehicle 20 immediately after finishing using the service or purchasing the product in the commercial facility and make payment by the second settlement device 21. Furthermore, even in a case where the vehicle service is not included in the service which is the target of the first settlement, the user 2 can make payment by the second settlement device 21 at once. In a case where the user 2 uses the vehicle service, the first settlement and the second settlement can be collectively completed by the second settlement device 21, so the convenience of the user 2 is further improved.

What is claimed is:

1. A management apparatus that manages a first settlement device that performs a settlement for use of a service or purchase of a product and a second settlement device mounted on a vehicle used by a user,
the management apparatus comprising one or more processors, wherein
the one or more processors are configured to execute:
permitting the first settlement device to perform a first settlement for the use of the service or the purchase of the product until the user using the service or purchasing the product gets in the vehicle; and
permitting at least the second settlement device to perform the first settlement after the user using the service or purchasing the product gets in the vehicle.

2. The management apparatus according to claim 1, wherein
the one or more processors are further configured to execute
prohibiting the vehicle from traveling until the first settlement is completed by the first settlement device or the second settlement device.

3. The management apparatus according to claim 1, wherein
the second settlement device is configured to be able to perform a second settlement for a vehicle service using the vehicle.

4. The management apparatus according to claim 3, wherein
the one or more processors are further configured to execute
permitting the second settlement device to collectively perform the first settlement and the second settlement when permitting the second settlement device to perform the first settlement.

5. The management apparatus according to claim 3, wherein
the vehicle service is a transfer service using the vehicle or an automated valet parking service.

6. The management apparatus according to claim 1, wherein
the one or more processors are configured to further execute:
permitting both the first settlement device and the second settlement device to perform the first settlement after the user gets in the vehicle; and
when the first settlement is completed by any one of the first settlement device and the second settlement device, prohibiting another one of the first settlement device and the second settlement device from performing the first settlement.

7. The management apparatus according to claim 1, wherein
the one or more processors are further configured to execute:
permitting only the first settlement device to perform the first settlement until the user using the service or purchasing the product gets in the vehicle; and
permitting only the second settlement device to perform the first settlement after the user using the service or purchasing the product gets in the vehicle.

8. A management method for managing a first settlement device that performs a settlement for use of a service or purchase of a product and a second settlement device mounted on a vehicle used by a user,
the management method comprising:
permitting the first settlement device to perform a first settlement for the use of the service or the purchase of the product until the user using the service or purchasing the product gets in the vehicle; and
permitting at least the second settlement device to perform the first settlement after the user using the service or purchasing the product gets in the vehicle.

9. A settlement system including a first settlement device that performs a settlement for use of a service or purchase of a product and a second settlement device mounted on a vehicle used by a user,
the settlement system comprising one or more processors, wherein
the one or more processors are configured to execute:
permitting the first settlement device to perform a first settlement for the use of the service or the purchase of the product until the user using the service or purchasing the product gets in the vehicle; and
permitting at least the second settlement device to perform the first settlement after the user using the service or purchasing the product gets in the vehicle.
